(19) United States
(12) Patent Application Publication
(10) Pub. No.: US 2002/0059930 A1
(43) Pub. Date: May 23, 2002

(54) Catalytic converter for an oven

(76) Inventors: Gerhard Schmidmayer, Bad Endorf (DE); Frank Jordens, Traunreut (DE); Olaf Fischer, Tittmoning (DE)

Correspondence Address: LERNER AND GREENBERG, P.A., Post Office Box 2480, Hollywood, FL, 33022-2480, US

(21) Appl. No.: 09/935,354

(22) Filed: Aug. 22, 2001

Related U.S. Application Data
(63) Continuation of application No. PCT/EP00/00829, filed on Feb. 2, 2000.

(30) Foreign Application Priority Data
Feb. 22, 1999 (DE) 199 07 554.9

(51) Int. Cl. A21B 1/00; B01D 53/34

(52) U.S. Cl. 126/19 R; 126/21 R; 422/177

(57) ABSTRACT

A catalytic converter for use in an oven includes at least two sub-catalysts connected in series. One of the sub-catalysts includes a catalytically active metal layer as its active surface to improve the efficiency of the catalytic converter with respect to the elimination of unpleasant odors. The one sub-catalyst includes a metal oxide as its active surface. At least one other sub-catalyst includes, as its active surface, a metal layer selected from elements in groups 8 to 10 of the periodic table.

### CROSS-REFERENCE TO RELATED APPLICATION

This application is a continuation of copending International Application No. PCT/EP00/00829, filed Feb. 2, 2000, which designated the United States.

### BACKGROUND OF THE INVENTION

### Field of the Invention

The invention relates to a catalytic converter for use in an oven including at least two sub-catalysts that are connected in series. One of the sub-catalysts includes a catalytically active metal layer as its active surface. The invention also relates to a correspondingly equipped oven.

German Published, Non-Prosecuted Patent Application DE 196 38 665 A1 teaches a catalytic converter that includes three metal meshes connected in series. The first and last meshes in the series serve as sub-catalysts and are provided with different noble metal layers, such as palladium and platinum. An uncoated neutral filter gauze is disposed between the two sub-catalysts.

### SUMMARY OF THE INVENTION

It is accordingly an object of the invention to provide a catalytic converter for an oven that overcomes the hereinafore-mentioned disadvantages of the heretofore-known devices of this general type and that further improves the efficiency of a catalytic converter for utilization in an oven with respect to the elimination of unpleasant odors, the catalytic converter having at least two sub-catalysts connected in series, one of which includes a catalytically active metal layer as its active surface.

With the foregoing and other objects in view, there is provided, in accordance with the invention, a catalytic converter for an oven including at least two sub-catalysts connected in series, at least one sub-catalyst of the subcatalysts having a catalytically active surface made from a metal oxide layer, and at least another sub-catalyst of the sub-catalysts having a catalytically active surface made from a metal layer selected from the group of elements consisting of groups 8, 9, and 10 of the periodic table. An oven including the catalytic converter in an oven muffle is also envisioned. Preferably, a first sub-catalyst has the catalytically active surface made from a metal oxide layer, a second has a catalytically active surface made from the metal layer selected from groups 8, 9, and 10, and the second sub-catalyst is connected to the first sub-catalyst downstream with respect to an exhaust flow direction. Improvement in the efficiency of a catalytic converter with respect to the elimination of unpleasant odors is achieved in that at least one sub-catalyst has a metal oxide layer as its active surface, and another sub-catalyst has a metal layer selected from Groups 8 to 10 of the periodic table. The cooperation of the two sub-catalysts guarantees that unpleasant odors, which arise in the cooking process and are exhausted from the cooking space, are efficiently broken down. Pre-combustion and post-combustion processes are also carried out according to the invention. The catalytic converter is particularly efficient when the first sub-catalyst, which is connected upstream with respect to an oven exhaust direction, has a metal oxide layer as its active surface, and the second catalyst, which is connected downstream thereof, has a metal layer from Groups 8 to 10 of the periodic table as its active surface. Furthermore, connecting the separate first sub-catalyst upstream guarantees that the downstream second sub-catalyst is protected from poisoning and the associated functional ineffectiveness.

In accordance with another feature of the invention, the carrier of the first and/or second sub-catalyst is expediently formed by a suitable wire gauze or ceramic honeycomb having a large active surface. A suitable material selection guarantees that the catalysts retain a stable shape up to temperatures of approximately 600° C. Such high temperatures can even occur given conventional cooking temperatures of approximately 200° C., depending on the substances that must be catalytically processed. In addition, the potentially cramped connection of the catalytic converter to heating elements that are allocated to the cooking space must be taken into consideration.

In accordance with a further feature of the invention, the active surface of the first and/or second sub-catalyst is applied as a thin coating having an embossed microstructure. Craters, bulges, ridges, and so on form the microstructure, and, therefore, the coating itself has a very large active surface. In terms of production, it is particularly expedient when the coating is deposited in the μm range using the prior art sol-gel technique.

In accordance with an added feature of the invention, the catalytic converter is particularly effective when the active surface of at least one sub-catalyst is formed from oxides of metals from Groups 3 to 12 of the periodic table and/or rare earth metals, or a combination of these.

In accordance with an additional feature of the invention, the catalytically active surface of a sub-catalyst is made from a noble metal, particularly palladium or platinum.

In accordance with a concomitant feature of the invention, to protect the two sub-catalysts from contamination, a filter, namely a noble steel filter, is disposed upstream with respect to an oven exhaust direction.

Other features that are considered as characteristic for the invention are set forth in the appended claims.

Although the invention is illustrated and described herein as embodied in a catalytic converter for an oven, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, cross-sectional view of an oven including the catalytic converter according to the invention; and

FIG. 2 an enlarged, fragmentary, cross-sectional view of the catalytic converter of FIG. 1 fixed in a muffle of the oven.

### DESCRIPTION OF THE PREFERRED EMBODIMENTS

In all the figures of the drawing, sub-features and integral parts that correspond to one another bear the same reference symbol in each case.

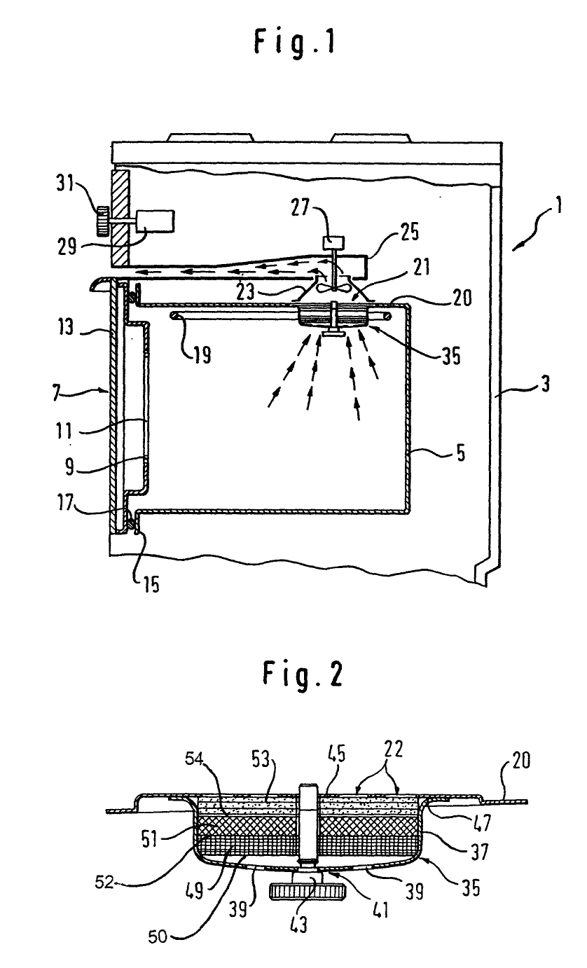

Referring now to the figures of the drawings in detail and first, particularly to FIG. 1 thereof, there is shown an oven 1 having a housing 3, which surrounds a muffle 5. The muffle 5 has a cladding of a conventional thermally insulating material and is sealable at its front side by a door 7. The door has a metallic bottom 9 in which a viewing window 11 is included. A front panel 13 is fixed to the door bottom 9 at a distance from the viewing window in a front region of the door 7. A seal 17 is disposed between the bottom 9 of the door and an oven flange 15 so as to substantially surround the entire muffle opening. The oven 1 can also be a device suitable for a pyrolitic self-cleaning operation, whereby all device components are exposed to particularly high operating temperatures.

Of the various prior art heating-elements of the oven 1, only one upper heating body 19 is represented. The upper heating body 19 is fixed beneath a covering wall 20 of the muffle 5. A waste vapor opening 21 having several individual openings 22 is additionally provided in the muffle. See FIG. 2. The waste vapor opening 21 is connected by way of a funnel-shaped connector piece 23 to a blow-out or exhaust shaft 25 that opens into the environment above the door 7 in the front region of the oven 1. A blower 27 for drawing air from the muffle 5 is disposed in the blow-out shaft 25. A control device 29 for controlling all operating modes of the oven 1 (e.g., baking and cleaning) can be realized by several manual controls 31 in the front region of the oven 1.

A catalytic converter 35 is disposed in a region of the waste vapor opening 21. The catalytic converter 35 sits in a pot-shaped housing 37 made of a material with good thermal conductivity, in whose bottom several suction openings 39 are constructed. In the middle of the floor of the housing 37, there is a fastening opening 41, through which the fastening screw 43 can be pushed through the catalytic converter 35 and screwed into a fastening plate 45 of the covering wall 20 of the muffle 5. Thus, a curved edge 47 of the housing 37 is pressed to the covering wall 20.

Three wire meshes 49, 51, 53 are disposed in series touching one another and touching the interior covering wall 20 of the housing 37 over large surfaces. The first mesh 49 is formed by an uncoated noble steel wire, which serves as a neutral filter, i.e., a grease filter 49, and which protects two downstream catalysts 51, 53, particularly from contamination (downstream being with respect to the exhaust direction). The second mesh forms the first sub-catalyst 51. The wire that is used for the first sub-catalyst 51 is coated with a metal oxide, such as an oxide of a transition metal such as cerium or manganese, and serves to pre-treat the air that must be cleaned. The mesh of the second sub-catalyst 53 is formed from a metal wire coated with platinum and serves to burn and neutralize the substances that are unpleasant to the human nose. To protect the second sub-catalyst 53 from poisoning, particularly by sulfurous compounds, and from the ineffectiveness associated with such poisoning, the air that is to be cleaned, i.e., the waste vapor, is first subjected to the catalytic reaction with the first sub-catalyst 51. The reaction product is then fed to the second sub-catalyst 53. Using the sol-gel technique, the active surfaces of the sub-catalysts 51, 53 are realized as thin layers in the um region having an embossed microstructure to enlarge the active catalytic surface. The active surfaces are diagrammatically represented with reference numerals 50, 52, and 54, respectively in the exhaust direction.

We claim:

1. A catalytic converter for an oven, comprising:
at least two sub-catalysts connected in series;
at least one sub-catalyst of said sub-catalysts having a catalytically active surface made from a metal oxide layer; and
at least another sub-catalyst of said sub-catalysts having a catalytically active surface made from a metal layer selected from the group of elements consisting of groups 8, 9, and 10 of the periodic table.

2. The catalytic converter according to claim 1, wherein said catalytically active surface is a thin deposited coating including an embossed microstructure.

3. The catalytic converter according to claim 2, wherein said catalytically active surface is sol-gel deposited.

4. The catalytic converter according to claim 1, wherein said at least two sub-catalysts has a carrier made from one of:
a wire mesh; and
a ceramic honeycomb.

5. The catalytic converter according to claim 1, wherein:
said at least two sub-catalysts are to be exposed to a flow having an exhaust direction;
said at least one sub-catalyst is a first sub-catalyst with a catalytically active surface made from a metal oxide layer; and
said at least another sub-catalyst is a second sub-catalyst with a catalytically active surface made from a metal layer selected from the group of elements consisting of groups 8, 9, and 10 of the periodic table, said second sub-catalyst is connected to said first sub-catalyst downstream with respect to the exhaust direction.

6. The catalytic converter according to claim 5, wherein said catalytically active surface of at least one of said first sub-catalyst and said second sub-catalyst is a thin deposited coating including an embossed microstructure.

7. The catalytic converter according to claim 6, wherein said catalytically active surface is sol-gel deposited.

8. The catalytic converter according to claim 5, wherein at least one of said first sub-catalyst and said second sub-catalyst has a carrier made from one of:
a wire mesh; and
a ceramic honeycomb.

9. The catalytic converter according to claim 1, wherein said catalytically active surface of said at least one sub-catalyst is made from oxides of metals selected from the groups of elements consisting of groups 3 to 12 of the periodic table.

10. The catalytic converter according to claim 9 wherein said metals are selected from the group consisting of manganese, rare earth metals, and a combination of manganese and said rare earth metals.

11. The catalytic converter according to claim 10, wherein said rare earth metals is cerium.

12. The catalytic converter according to claim 1, wherein said catalytically active surface of said at least one sub-catalyst is made from at least one of:
oxides of metals selected from the groups of elements consisting of groups 3 to 12 of the periodic table; rare earth metals; and
a combination of oxides of metals selected from the groups of elements consisting of groups 3 to 12 of the periodic table and said rare earth metals.

13. The catalytic converter according to claim 1, wherein said catalytically active surface of said at least another sub-catalyst is made from a noble metal.

14. The catalytic converter according to claim 13, wherein said noble metal includes one of palladium and platinum.

15. The catalytic converter according to claim 1, wherein said at least two sub-catalysts are to be exposed to a flow having an exhaust direction; and
a filter is disposed upstream of said at least two sub-catalysts with respect to the exhaust direction.

16. The catalytic converter according to claim 15, wherein said filter is a noble steel filter.

17. An oven, comprising:
an oven muffle; and
a catalytic converter disposed in said oven muffle, said catalytic converter having:
at least two sub-catalysts connected in series;
at least one sub-catalyst of said sub-catalysts having a catalytically active surface made from a metal oxide layer; and
at least another sub-catalyst of said sub-catalysts having a catalytically active surface made from a metal layer selected from the group of elements consisting of groups 8, 9, and 10 of the periodic table.
